(19) United States
(12) Patent Application Publication
(10) Pub. No.: US 2020/0348104 A1
(43) Pub. Date: Nov. 5, 2020

(54) INTEGRATED RECHARGEABLE POWER AND POWER MANAGEMENT TECHNOLOGY FOR INDIVIDUAL WEAPON MOUNTED ELECTRONIC DEVICES

(71) Applicant: Christopher M. Chambers, Oviedo, FL (US)

(72) Inventor: Christopher M. Chambers, Oviedo, FL (US)

(73) Assignee: SERIOUS SIMULATIONS, LLC, Orlando, FL (US)

(21) Appl. No.: 16/878,260

(22) Filed: May 19, 2020

Related U.S. Application Data
(63) Continuation-in-part of application No. 16/005,285, filed on Jun. 11, 2018, now Pat. No. 10,655,928.
(60) Provisional application No. 62/517,903, filed on Jun. 10, 2017.

(51) Int. Cl. F41C 23/22; H01M 10/44; H01M 10/48; F41G 11/00; F41C 27/00

(52) U.S. Cl. CPC F41C 23/22; H01M 10/44; H01M 2220/30; F41G 11/00; F41C 27/00; H01M 10/488

(57) ABSTRACT

The present invention provides for devices and methods for making and using an integrated rechargeable power supply and power management system for providing uninterruptable power to weapon mounted electronic devices even during swapping of the battery. The inventive apparatus provides for a common power source for weapon attachments, which can be integrated into a weapon. These devices and methods provide for an easy swap of the power source in an active environment, and further include power management and safety functions. The inventive devices and methods further provide for better ergonomics and improved weight/balance to enhance shooting skills, less physically taxing heft, and potentially save lives. Finally, the present invention is backwards compatible with present weapons.

### CROSS-REFERENCE TO RELATED APPLICATION

This claims priority from U.S. Provisional Application No. 62/517,903, filed Jun. 10, 2017, and is a continuation in part of co-pending U.S. application Ser. No. 16/005,285, filed Jun. 11, 2018, each of which is incorporated by reference herein in their entirety.

### FIELD OF THE INVENTION

The invention relates generally to the field of providing integrated electrical power distribution to a weapon. More particularly, this invention relates to a removable and rechargeable power supply to provide power distribution system the operation of weapon mounted electronic devices.

### BACKGROUND OF THE INVENTION

Modern weaponry can be equipped with a plurality of electronic devices which aid its operator in its use, weather mission specific, improved accuracy, or to enhance vision. For example, flashlights, lasers, range finders, sighting devices, combat optics, laser designators/sights, and night vision can be typically integrated and mounted to most current weapons. Each individual device is designed in isolation by a variety of manufacturers and engineers. Each device provides its own power source, leading to unwanted and inefficient bulk, additional real estate on the rail system, weight, multiple battery inventories, multiple battery lives to be monitored individually, and redundant multiple battery compartment design expenses. The result is a heavy and imbalanced weapon and a heavier field load of batteries to accommodate the various accessories, which ultimately impacts the operators effectiveness.

The incorporation of a commonpower source in a weapon has been attempted, but all k methods fall short of providing an optimal common power source due to many factors such as weight imbalance, ease of removability, types and number of batteries, etc. Some solutions have attempted to install a battery compartment in existing buttstock. To change the battery an operator must open the battery compartment, remove the old battery, replace the new battery and secure the battery compartment. In an active environment, the timing of the battery swapping can be excessive. Moreover, the solutions offered presently do not distribute the weight throughout the entire buttstock of a weapon, thus creating an imbalance within the buttstock itself. Thus there remains an unmet need for a common power source, that can be integrated into a weapon, that it easy to swap in an active environment, with power management and safety functions, and better ergonomics and improved weight/balance to enhance shooting skills, less physically taxing heft, and potentially save lives. Furthermore there further remains an unmet need for such integrated common power source that is backwards compatible with present weapons.

### SUMMARY OF INVENTION

The present invention provides for devices and methods of an integrated rechargeable power supply and power management system for providing power to weapon mounted electronic devices. Embodiments of the invention include the incorporation of batteries, power distribution circuits, an enclosure, a connection mechanism and a release mechanism. The inventive apparatus provides for a common power source for weapon attachments, that can be integrated into a weapon. These devices and methods provide for an easy swap of the power source in an active environment, and further includes power management and safety functions.

In some aspects of the invention, the battery buttstock unit accomplishes essential electrical power functions never before implemented in as an integrated mechanically functional component of a weapon.

Aspects of the invention implement power provision/distribution, power protection, and power management for the electronic devices placed on the weapon.

In some aspects, additional provisions are implemented by use of a conformal battery inside the mechanically functional buttstock or other weapon component such as a pistol grip, rail assembly, or forearm guard.

Aspects of the invention allow for specific electrical power to be provided for sufficient capacity in voltage and amperage to properly operate all the electronics in use on the weapon for a desired period of time, and is distributed via wiring, connectors, printed circuit board hubs, or any other distribution method that permits unobstructed operation of the mechanical weapon.

Aspects of the invention allow for the distribution method to be quick releasable through use of a magnetic pogo pin or other quick release connector arrangement, such that the buttstock unit can be pulled off as normal with no additional manual steps needed to disconnect the power circuitry.

In some aspects, power management is implemented so that electrical power is provided in a clean fashion, without spikes and surges through use of one or more regulators and filters.

In some further aspects, the device further manages power flow for sufficient steady power under heavy electrical loads.

And in other aspects, a power protection circuit is used to protect the user from the battery overcharging, and/or discharging at too fast a rate, and prevents it from discharging the battery to too low a level, as all these conditions can cause the battery to be unstable and unsafe.

The inventive devices and methods further provide for better ergonomics and improved weight/balance to enhance shooting skills, less physically taxing heft, and potentially save lives. Finally, the present invention is backwards compatible with present weapons.

### BRIEF DESCRIPTION OF THE DRAWINGS

The present invention is further detailed with reference to the following figures. These figures are not intended to be a limitation on the scope of the invention, but rather to illustrate specific aspects of the invention.

FIG. 1 provides one embodiment of the 100 inventive buttstock illustrating the 102 connection mechanism for interfacing and securing to the proximal end of a weapon while providing a power connector for providing power to the weapon accessories. The 101 release mechanism provides for the ability to quickly release the buttstock for hot swapping to another, preferably fully charged, buttstock system. The 103 charging port allows for the charging of the battery buttstock. The 200 charger is one example of an available charger.

FIG. 2 is an additional embodiment of the inventive 100 buttstock system.

FIG. 3 illustrates at least one embodiment of the inventive buttstock having a 130 LED display for displaying the amount of charge of the batteries contained as part of the 100 buttstock system.

FIG. 4 illustrates at least one embodiment of a wire and component diagram of at least one embodiment of the inventive 100 buttstock system.

FIG. 5 illustrates at least one embodiment of a wire and component diagram of at least one embodiment of the inventive 100 buttstock system.

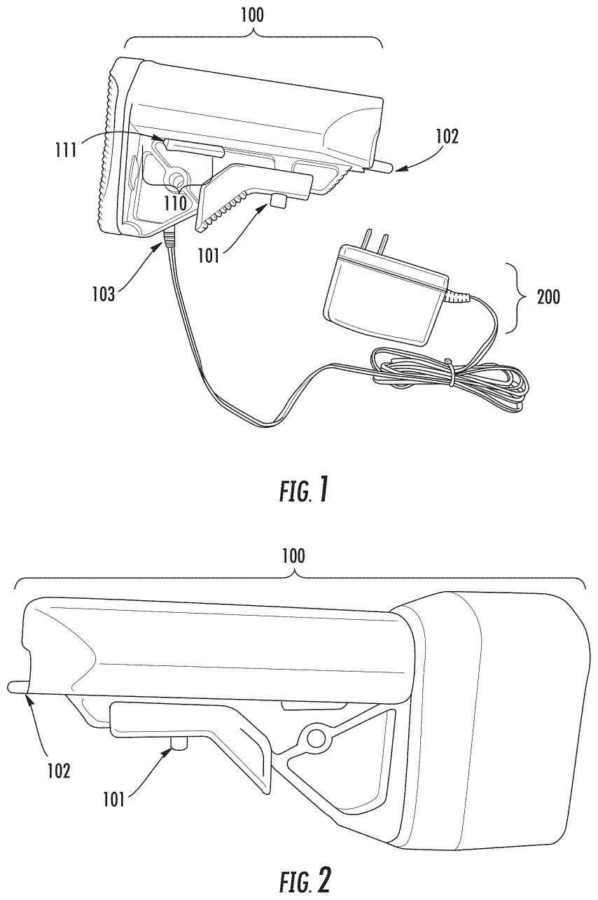

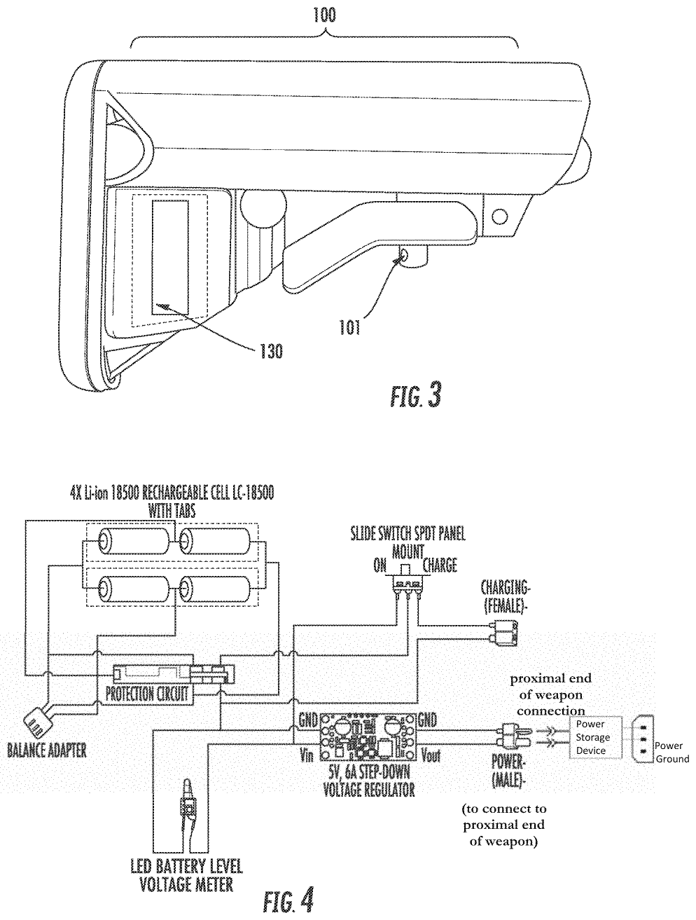

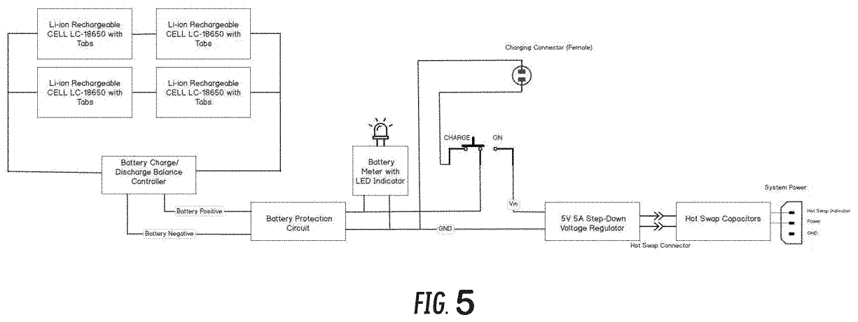

### DETAILED DESCRIPTION OF THE INVENTION

The present invention has utility for providing a specially made butt stock for common weapon types which is both an adjustable and removable butt stock, with and internally integrated electric power source, distribution center for power to multiple devices, and a power management and safety system. The butt stock itself is essentially a power and is easily removed with one thumb lever, exactly as the simple butt stock is currently removed. The battery butt stock has a charging port or cradle to recharge as a single unit. Individuals can carry multiple butt stock power systems and replace their power source in a few seconds without power interruption. A hot-swappable capability is provided downstream from the butt stock power unit in the form of a capacitor, capacitor bank, battery, or other power storage device capable of retaining essential power to keep electronic devices running during power source switching. Other embodiments include the ability for wireless recharging of the buttstock while the inventive battery buttstock is or is not integrated with a weapon or is or is not in use.

The following detailed description is merely exemplary in nature and is in no way intended to limit the scope of the invention, its application, or uses, which may vary. The invention is described with relation to the non-limiting definitions and terminology included herein. These definitions and terminology are not designed to function as a limitation on the scope or practice of the invention, but are presented for illustrative and descriptive purposes only.

It is to be understood that in instances where a range of values are provided that the range is intended to encompass not only the end point values of the range but also intermediate values of the range as explicitly being included within the range and varying by the last significant figure of the range. By way of example, a recited range of from 1 to 4 is intended to include 1-2, 1-3, 2-4, 3-4, and 1-4.

### Integrated Power Buttstock

A replacement buttstock having an integrated rechargeable power supply, power management system, and power protection circuitry for providing power to weapon mounted electronic devices is provided. The replacement buttstock is intended to be swapped as needed to provide power to the weapon accessories, as may be needed from time to time. In at least one embodiment, the replacement buttstock is an enclosure having at least one rechargeable battery. In at least one embodiment, the buttstock encloses a plurality of rechargeable batteries. In at least one embodiment the batteries are distributed within the buttstock enclosure to provide uniform weight distribution throughout the buttstock. Where used, even weight distribution about the buttstock prevents from the weight of the battery system internal to the buttstock from affecting the handling and weight of the weapon.

In at least one embodiment, the buttstock further encloses a power distribution circuit, power management circuit, power protection circuit, and a charging port which is in wired communication with the at least one battery for charging said battery, a power connector for interfacing with at least one connector for supplying power to at least one weapon mounted device, or combinations thereof. The charging port, where used, can be any charging port known in the art. The power connector, where used, can be any connector known in the art. The power distribution circuit includes a switch, a protection circuit, a voltage regulator, a balance adapter, an LED battery level voltage meter, an LED display, or combinations thereof.

In at least one embodiment, the power protection circuit utilizes commercial of the shelf (COTS) protection circuitry. It should be appreciated that implementation of COTS protection is novel on a weapon and to date, no weapon exists using a COTS protection. In at least one embodiment, the COTS protection circuit is implemented to protect a user from conditions which can cause the battery to be unstable and unsafe. Such conditions include, without limit, the battery overcharging, discharging at too fast a rate, discharging the battery too slow, or combinations thereof.

It should be appreciated that a novel aspect of the present invention is that the buttstock is removed and replaced when power is running low, as opposed to replacing a battery or a plurality of batteries, without losing power to the weapons accessories. Swapping only the buttstock provides a tactical advantage by being able to hot swap a buttstock in a minimal number of steps, while also interfacing with existing buttstock connections. In at least one embodiment, the buttstock system includes at least one connection mechanism for connecting and securing the buttstock to the proximal end of a weapon and a releasable connection for the power distribution function. In at least one embodiment, the buttstock system includes at least one release mechanism for disengaging the buttstock from the proximal end of the weapon.

In at least one embodiment, the buttstock contains additional circuitry to enable wireless charging of the buttstock.

One example of an accessory for a weapon is a scope which includes a reticle which can be illuminated for use in low light or daytime conditions. Illumination is usually provided by a battery powered LED, though other electric light sources can be used. Other examples of powered accessories include, but are not limited to: tactical lights, laser aiming modules, sensors, video cameras, audio cameras, edge computing devices, wireless communication devices, virtual reality or augmented reality interface devices, micro-electromechanical systems (MEMS), inertial sensors, and night vision devices.

Inventive battery buttstocks are intended to mimic current weapons buttstock known in the art, including Sopmod buttstock. It is intended that removal and replacement of each battery buttstock is specific to the weapon, thus nothing herein is intended to limit the connection mechanisms, release mechanisms, or electrical connection circuitry. It should be further appreciated that males and female connectors may be alternated, and nothing herein is intended to limit the use of a male connector to only a male connector, and the inverse connections may be implemented. Other embodiments allow for a myriad of buttstock depending on weapon style, and further include collapsible and/or other removable buttstocks such as for AK47s and a myriad of other weapons.

### Battery

The battery may be one or more batteries and is intended to be any battery which is designed to be rechargeable, and having enough capacity to be able to power weapon accessories for a reasonable amount of time, as may be tactically necessary. In at least one embodiment, the battery may be of lead-acid, nickel cadmium (NiCd), nickel metal hydride (NiMH), lithium ion (Li-ion), or lithium ion polymer (Li-ion polymer).

### Other Embodiments

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the described embodiments in any way. Rather, the foregoing detailed description will provide those skilled in the art with a convenient road map for implementing the exemplary embodiment or exemplary embodiments. It should be understood that various changes can be made in the function and arrangement of elements without departing from the scope as set forth in the appended claims and the legal equivalents thereof.

The foregoing description is illustrative of particular embodiments of the invention, but is not meant to be a limitation upon the practice thereof. The following claims, including all equivalents thereof, are intended to define the scope of the invention.

1. An integrated rechargeable power supply and power management system for providing power to weapon mounted electronic devices, the system comprising:
at least one battery;
at least one power distribution circuit;
a removable enclosure formed as a buttstock, said enclosure for holding said at least one battery and at least one power distribution circuit;
a power storage device electrically included in said weapon and electrically downstream of a power connector of said buttstock and said weapon, said power storage device sufficient to retain essential power to keep electronic devices temporarily energized during buttstock swapping;
at least one buttstock power connector on said buttstock in electrical communication with said at least one battery;
at least one weapon power connector on said proximal end of the weapon configured to interface with said at least one buttstock power connector;
at least one connection mechanism for connecting and securing the buttstock to the proximal end of the weapon; and
at least one release mechanism for disengaging the buttstock from the proximal end of the weapon.

2. The system of claim 1 further comprising a female charging port which is in wired communication with the at least one battery for charging said battery.

3. The system of claim 1 further comprising a power connector for interfacing with at least one connector for supplying power to at least one weapon mounted device.

4. The system of claim 1 wherein said power distribution circuit includes at least one of a switch, a protection circuit, a voltage regulator, a balance adapter, an LED battery level voltage meter, an LED display, or combinations thereof;

5. The system of claim 1 wherein said power storage device is a capacitor, capacitor bank, battery, or other power storage device capable of retaining essential power to keep electronic devices running during power source switching.

6. A buttstock for use with a weapon which includes powered accessories requiring power, the buttstock comprising:
at least one battery;
at least one power distribution circuit;
a power storage device electrically included in said weapon and electrically downstream of a power connector of said buttstock and said weapon, said power storage device sufficient to retain essential power to keep electronic devices temporarily energized during buttstock swapping;
at least one connection mechanism for connecting and securing the buttstock to the proximal end of the weapon; and
at least one release mechanism for disengaging the buttstock from the proximal end of the weapon.

7. The buttstock of claim 6 further comprising a charging port which is in wired communication with the at least one battery for charging said battery.

8. The buttstock of claim 6 further comprising a power connector for interfacing with at least one connector for supplying power to at least one weapon mounted device.

9. The buttstock of claim 6 wherein said power storage device is a capacitor, capacitor bank, battery, or other power storage device capable of retaining essential power to keep electronic devices running during power source switching.
